(19) United States
(12) Patent Application Publication
(10) Pub. No.: US 2008/0003538 A1
(43) Pub. Date: Jan. 3, 2008

(54) GINGIVAL RETRACTION CORD WITH WETTING AGENT

(75) Inventor: Paul Wittrock, Simi Valley, CA (US)

Correspondence Address: KELLY LOWRY & KELLEY, LLP, 6320 CANOGA AVENUE, SUITE 1650, WOODLAND HILLS, CA, 91367, US

(73) Assignee: DUX INDUSTRIES, INC., Oxnard, CA (US)

(21) Appl. No.: 11/306,474

(22) Filed: Dec. 29, 2005

Related U.S. Application Data
(60) Provisional application No. 60/641,128, filed on Dec. 30, 2004.

(51) Int. Cl. A61C 3/00

(52) U.S. Cl. 433/136

(57) ABSTRACT

A retraction cord for retracting gingival tissue is pre-impregnated with a chemical agent for chemically retracting gingival tissue and/or a hemostatic agent for arresting bleeding. A wetting agent is further applied to the cord to ensure product efficacy and shelf stability. The retracting agent may be an astringent water soluble organic salt such as aluminum potassium sulfate, aluminum sulfate, aluminum chloride, or ferric sulfate-or an inorganic salt of organic vascoconstrictors such as epinephrine, pseudoephedrine, or VISINE. The wetting agent is preferably a non-ionic surface active surfactant such as SILWET L-7607 at a concentration of 0.05% by volume.

### BACKGROUND OF THE INVENTION

The present invention generally relates to methods and apparatus used in gingival tissue management for the preparation of an impression, such as those used in artificial crowns and bridges and the like. More particularly, the present invention is directed to a gingival retraction cord for retracting gingival tissue preparatory to making such impressions of a tooth, the cord having a wetting agent so as to facilitate the taking of the impression and improve the results thereof.

It has become a common dental procedure to replace a damaged or malformed crown of a tooth with an artificial crown constructed of porcelain and/or gold. A well-fitting and properly contoured artificial crown will give many years of excellent service to its wearer. An improper fit, on the other hand, will result in premature failure and detachment of the artificial crown from the tooth. It has been found that in order to construct artificial crowns capable of remaining secured to the tooth in a physiologically sound condition for an extended period of time, it is critical to make an accurate impression in the area of margin. Failure to do so can result in decay around the area of the margin, or other physiological problems. Thus, premature failure of a crown is almost always due to poor marginal detail in the impression used to fabricate the crown.

Issues that concern a dental practitioner in taking an accurate impression for placing an artificial crown include:

the gingival cuff must be horizontally retracted or distended from around the marginal area of the tooth sufficient to permit an adequate bulk of impression material to be placed around the margin of the tooth;

the gingival tissue must be displaced vertically in order to expose a portion of the tooth below the margin so that the impression will clearly indicate the location of the margin and will give good marginal detail;

all hemorrhaging must be arrested prior to taking the impression; and

the area where the impression is to be taken must be thoroughly cleaned and dried.

The gum or gingival cuff is typically retracted through the use of one or more retraction cords that are inserted into the gingival sulcus. However, current retraction cords do not adequately address the issues set forth above.

Accordingly, there is a continuing need for a retraction cord which can be inserted dry and yet have sufficient wet-ability so as to soak up saliva, blood, and release the necessary chemical retracting agents embedded and chemical hemostatic agents embedded within the retracting cord so as to stop bleeding and create a dry field for the optimal high quality impression. The present invention fulfills these needs and provides other related advantages.

### SUMMARY OF THE INVENTION

The present invention resides in a retraction cord for retracting gingival tissue wherein the cord is pre-impregnated with a chemical agent and, in addition, has a wetting agent applied to the cord. The chemical agent can be either a retracting agent, a hemostatic agent, or both. The retraction cord may be a twisted cord, a braided cord, a knitted cord, or a cord including a ductile metal strand.

Where the chemical agent is a retracting agent, the retracting agent may be an astringent water soluble inorganic salt or an inorganic salt of organic vascoconstrictors. Astringent water soluble inorganic salts include aluminum potassium sulfate, aluminum sulfate, aluminum chloride, or ferric sulfate. Inorganic salts of organic vascoconstrictors are epinephrine, pseudoephedrine, or “Visine”™.

The wetting agent may be an anionic, cationic, or non-ionic surface active surfactant. The wetting agent is preferably a non-ionic surface active surfactant such as a ZONYL fluorocarbon, a PLURONIC block copolymer of ethylene and propylene oxide to an ethylene glycol base, a TWEEN polyoxyethylene sorbitan fatty acid ester, a TRITON X series octylphenoxy polyethoxy ethanol, a SURFYNOL tetramethyl decynediol, a SILWET L-7614 silicon surfactant, or a SILWET L7607 silicon surfactant. Preferably the wetting agent is SILWET L-7607 at a concentration of 0.05% by volume.

Other features and advantages of the present invention will become apparent from the following more detailed description, taken in conjunction with the accompanying drawings which, by way of example, illustrate the principles of the invention.

### BRIEF DESCRIPTION OF THE DRAWINGS

The accompanying drawings illustrate the invention. In such drawings:

FIG. 1 is a vertical section of a typical tooth and surrounding gingival tissue;

FIG. 2 is a view similar to FIG. 1 but showing the tooth after it has been suitably shaped by a high speed drill preparatory for a dental impression;

FIG. 3 is a view similar to FIG. 2 but showing the tendency of the gingival cuff to contract after completion of the shaping and prior to packing of the retraction cord;

FIG. 4 illustrates the portion of FIG. 3 indicated by the line 4-4, drawn to a larger scale and showing the step of packing a length of prior art type retraction cord into the gingival sulcus;

FIG. 5 is a view similar to FIG. 3 but further illustrating the use of prior art types of retraction cord to retract the gingival tissue from around the margin of the shaped tooth;

FIG. 6 is an enlarged view of the portion of FIG. 5 taken along the line 6-6;

FIG. 7 is an enlarged view of the portion of FIG. 5 taken along the line 7-7; and

FIG. 8 is a view similar to FIG. 4 but showing the appearance of the retracted gingival tissue upon removal of the retraction cord.

### DETAILED DESCRIPTION OF THE PREFERRED EMBODIMENT

The present invention is directed to a retraction cord for retracting gingival tissue pre-impregnated with a retracting agent and/or hemostatic agent, and a wetting agent. However, in order to understand the present invention it is helpful to first review the process involved in fitting an artificial crown.

FIG. 1 illustrates a normal tooth 20 requiring restoration by use of an artificial crown. Tooth 20 is surrounded by gingival tissue 22 and 24 (gingival tissue is commonly referred to as the “gums”).

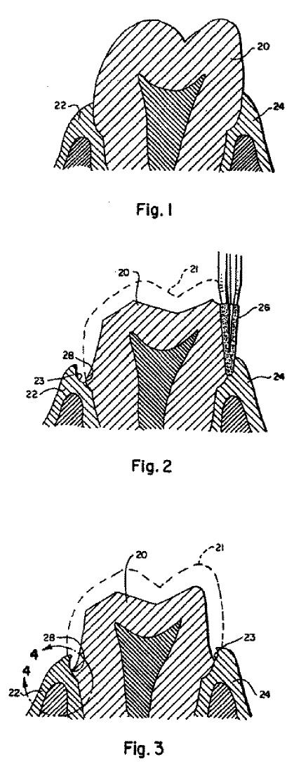

The dental practitioner first prepares the tooth to receive an artificial crown by removing portions of the tooth (shown by the broken line outline at 21) with a high-speed drill 26, as indicated in FIG. 2. The junction at which the uncut lower portion and the cut upper portion of the tooth meet is referred to as the “margin” 28.

Gingival supporting tissue 22, 24 is comprised largely of collagen fibers. Because these collagen fibers are highly elastic, the gingival cuff will begin to constrict around the margin 28 of the cut tooth almost immediately after the tooth has been shaped to receive a crown (see FIG. 3). This prevents adequate amounts of impression material from being placed around the margin 28 of the tooth 20. In addition, damage to the gingival tissue 22, 24 during cutting of the tooth 20 results in bleeding around the periphery of the tooth into the space formed between the gingival tissue 22, 24 and the tooth 20, this space generally being referred to in the art as the “gingival sulcus” 23, which is shown in FIGS. 2 and 3. This bleeding further interferes with the taking of a good impression because extravasated blood tends to prevent adequate cleaning and drying of the marginal area of the tooth prior to taking an impression and tends to displace the impression material before it can set.

Thus, the dual problems of contraction of the gingival cuff and the presence of hemorrhaging tissues make it impractical to simply take an impression following shaping of the tooth with the high-speed drill. As discussed above, four basic requirements have been identified for the taking of consistently acceptable impressions. First, the gingival cuff must be horizontally retracted or distended from around the marginal area of the tooth sufficient to permit an adequate bulk of impression material to be placed around the margin of the tooth. Second, the gingival tissue must be vertically retracted in order to expose a portion of the tooth below the margin so that the impression will clearly indicate the location of the margin and will give good marginal detail. Third, all hemorrhaging must be arrested prior to taking the impression. Fourth, the area where the impression is to be taken must be thoroughly cleaned and dried.

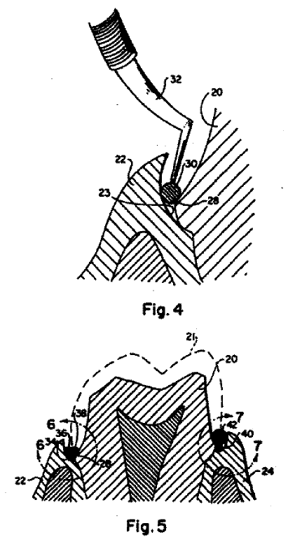

The most common method for providing horizontal and vertical retraction is by use of retraction cord. Thus, as illustrated in FIG. 4, a length of retraction cord 30 is packed between gingival tissue 22 and the margin 28 of tooth 20 by use of an appropriate dental instrument 32.

Gingival retraction cords are small, multi-element cords constructed of individual threads. Typical final forms are braided, knitted, or twisted. The cords typically range in diameter from 0.015 to 0.050 inches and can be made of any fiber imagined. The most widely used fibers are cotton, polyester, or cotton-poly blends. There are other forms which include such oddities as multi-thread twisted cotton cords having a single strand formed from a ductile metal. Monofilament cords have been envisioned but there are none presently in commercial distribution. In use, all retraction cords 30 are cut into short lengths and then packed circumferentially around the base of the tooth 20 in the gingival sulcus 33.

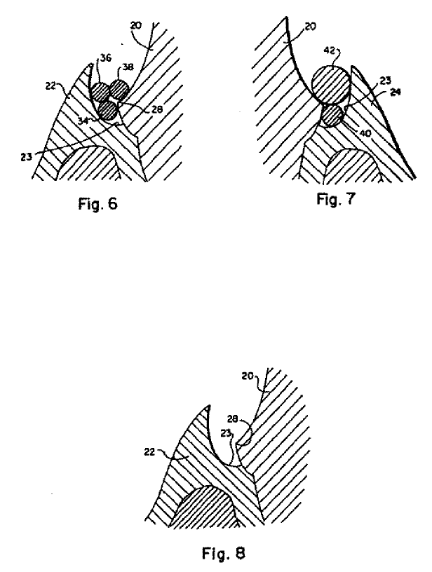

It is often necessary to pack several lengths of retraction cord into the sulcus 23 in order to obtain sufficient vertical and horizontal retraction of gingival tissue. FIG. 5 illustrates two possible approaches for utilizing multiple lengths of retraction cord. Thus, on the left side of tooth 20 it is indicated that three lengths of retraction cord 34, 36, and 38 might at times be used to obtain suitable gingival retraction. As better seen in FIG. 6, cord 34 causes vertical displacement of the gingival tissue in a direction toward the root of the tooth (“apical” displacement). This permits an accurate determination of the location of the margin 28. Cords 36 and 38 are then packed side-by-side over cord 34 and margin 28 so as to cause horizontal displacement of the gingival tissue. The result of the use of retraction cord is illustrated in FIG. 8; the margin 28 of the tooth is exposed sufficiently so that it is possible to make an impression having excellent marginal detail.

Returning to a consideration of FIG. 5, a second approach for retracting gingival tissue is illustrated on the right side of tooth 20. (It should be understood that in actual practice only a single approach would generally be taken with respect to a single tooth; the differences between the approaches taken on the right and left sides of tooth 20 in FIG. 5 are primarily for purposes of illustration.) In FIG. 5 it may be seen that it is possible to use only two retraction cords 40 and 42 to retract gingival tissue 24 in place of the three cords 34, 36 and 38 used in retraction of gingival tissue 22. Referring to FIG. 7, which is drawn to a larger scale, it may be seen that a small cord 40 corresponding to cord 34 of FIG. 6 can be used to accomplish vertical retraction, but a single cord 42 having a diameter approximately twice that of cord 40 may be used for obtaining the necessary horizontal retraction.

These short sections of cord are relatively stiff and therefore resist bending. This resistance to bending makes it difficult to hold the straight section of cord into a round shape and the cord then refuses to remain where placed. The first gingival retraction cords on the market were twisted forms similar in structure to those used to crochet or knit clothing. These cords are soft to the touch but tend to return to their original shape after bending. One less than ideal solution to this problem was the inclusion of the ductile metal strand. While addition of this strand eliminated the retention of shape problem the instruments used to pack the twisted cord can slip through the strands and into the gingival sulcus resulting in unnecessary tissue damage.

Other, more practical solutions to the retention of shape problem were developed, the first being the braided retraction cord. Braided forms are more flexible than the twisted predecessor product and prevent, or greatly limit, instrument pass though thereby limiting tissue damage. This form, with reasonable flexibility and improved placement integrity is widely used to this day. A second more recent improvement in the art is the knitted retraction cord. This form has less resistance to bending than either braided or twisted forms. The ideal retraction cord would be flexible enough to bend yet structured in such a way that instrument pass through is limited. No current form is ideal.

In practice of the standard forms, twisted, braided, or knitted, can be used in one of two ways. Wet placement of the cord is one option. This practice allows the doctor the freedom to choose the retraction solution and has the added advantage of eliminating the retention of shape problem. Wet cords do not resist bending to the extent that dry cords do. In fact, pre-wet braided cords, for example Gingigel™ have met with significant success in the market.

As mentioned above, gingival supporting tissue is comprised largely of flexible collagen fibers. Thus, although mere mechanical retraction is effective to some extent if the gingival tissue need not be displaced for more than a very short period of time after removal of the retraction cord, in practice it is usually preferable to apply a chemical retracting agent that reduces the tendency of the gingival tissue to contract over the margin after the retraction cord is removed. This is conveniently accomplished by soaking the retraction cord in a solution containing the chemical agent prior to packing the cord into the sulcus, or by pre-impregnating the cord with a suitable chemical agent. When such a suitable retracting agent and retraction cord are used, it is possible to maintain the gingival displacement illustrated in FIG. 8 for a period of time sufficient to permit the dental practitioner to make an accurate impression.

As mentioned above, another requirement for the taking of a good quality impression is the arresting of any hemorrhaging caused by damage to gingival tissue during shaping of the tooth. Accordingly, in addition to use of a chemical retracting agent, it has been found useful to apply a chemical hemostatic agent to discontinue blood flow from damaged blood vessels. Again, this chemical agent can be applied by soaking the retraction cord in an appropriate solution prior to placement. Typically, the same chemical agent used to assist retraction also has hemostatic properties.

While wet placement is ideal in theory with actual practice there are some limitations. Small diameter cords by their nature have a low surface area to volume ratio and are very light in weight. Consequently, typical cords are difficult to wet fully with retraction solutions. This lack of wet-ability is disadvantageous. The pre-wet cords solve this problem but there is another key limitation. The current state of the art in impression materials requires a “dry field” or elimination of saliva and gingival fluids in order to obtain a high quality impression. Wet placement falls contrary to the state of the art in impression taking.

Ultimately, the doctor is left with the option of placing a pre-impregnated dry cord, typically either knitted or braided, and dealing with the inherent problems of their form or using a pre-wet system and running the risk of compromising impression quality.

As discussed above, while wet placement of retraction cords is common, this practice presents many limitations and does not provide for the highest quality impression as the state of the art in impression taking generally requires a “dry field” surrounding the tooth. Although retraction cords are known which are impregnated with various chemical retracting agents to horizontally retract or distend the gingival cuff from the tooth, as well as chemical hemostatic agents to discontinue blood flow from damaged blood vessels, these small diameter cords by their very nature have a low surface area to volume ratio and are very light in weight and thus are difficult to wet fully even when placed dry around the tooth. Moreover, the typical cords do not wet fully with retraction solutions when performed in the “wet-placement” methodology.

The present invention resides in retraction cords which are pre-impregnated with the chemical retracting agents and/or chemical hemostatic agents and further include a wetting agent or surfactant. It has been found that the use of the appropriate wetting agent greatly increases the wetability of the cord.

Wetting agents, such as surface active surfactants are classified under three very broad categories: 1) anionic; 2) cationic; and 3) non-ionic.

The cationic and anionic forms dissociate in solution forming individual, charged surface active entities which can react with other ionic species in use. Non-ionic surfactants do not dissociate in solution, consequently they do not react with ionic compounds in solution.

Typical gingival retraction agents fall into two main classes. The first being astringent water soluble inorganic salts such as Aluminum Potassium Sulfate, Aluminum Sulfate, Aluminum Chloride, or Ferric Sulfate. Inorganic salts of organic vascoconstrictors such as epinephrine, pseudoephedrine, or “Visine”™ present the second class of gingival retraction solutions. In both cases, the use of a non-ionic surfactant is indicated to ensure product efficacy and shelf stability as any potential reaction between the surfactant and the retraction agent is prevented.

Various types of non-ionic sufactants can be used, including but not limited to: ZONYL fluorocarbons (e.g., ZONYL FSO, available from E.I. du Pont de Nemours and Co. Of Wilmington, Del.); PLURONIC block copolymers of ethylene and propylene oxide to an ethylene glycol base (available from BASF Corp. Chemicals Division of Mount Oliv, N.J.); TWEEN polyoxyethylene sorbitan fatty acid esters (available from ICI Americas, Inc. Of Wilmington, Del.); TRITON X series octylphenoxy polyethoxy ethanol (available from Rohm and Haas Co. Of Philadelphia, Pa.); SURFYNOL tetramethyl decynediol (available from Air Products and Chemicals, Inc. Of Allentown, Pa.); and SILWET L-7614 and L-7607 silicon surfactants (available from Union Carbide corp. of Danbury, Conn.) and the like known to those skilled in the art.

It has been found that a particularly preferred surfactant is the SILWET L-7607, at a concentration of 0.05% by volume. This surfactant when applied to the retraction cord, such as being impregnated therein or more typically coated thereon, increases the wetability of the retraction cord such that the dry cord wets rapidly by absorbing fluids and thus resistance to bending disappears.

As the cord wets, astringent or vasocontricting agents are delivered to the sulcus with the net result being rapid gingival retraction. Tissue damage is minimal especially with the braided form. The invention has the advantages of the pre-wet form with the added ability to dry the sulcus yielding a high quality impression.

Although an embodiment has been described in detail for purposes of illustration, various modifications may be made without departing from the scope and spirit of the invention.

1. A retraction cord for retracting gingival tissue, comprising:
a cord pre-impregnated with a chemical agent selected from the group consisting of a retracting agent and a hemostatic agent; and
a wetting agent applied to the cord.

2. The retraction cord of claim 1, wherein the wetting agent comprises a surface active surfactant.

3. The retraction cord of claim 2, wherein the wetting agent is a non-ionic surface active surfactant comprising a ZONYL fluorocarbon, a PLURONIC block copolymer of ethylene and propylene oxide to an ethylene glycol base, a TWEEN polyoxyethylene sorbitan fatty acid ester, a TRITON X series octylphenoxy polyethoxy ethanol, a SURFYNOL tetramethyl decynediol, a SILWET L-7614 silicon surfactant, or a SILWET L-7607 silicon surfactant.

4. The retraction cord of claim 3, wherein the wetting agent comprises SILWET L-7607 at a concentration of 0.05% by volume.

5. The retraction cord of claim 1, wherein the retracting agent comprises an astringent water soluble inorganic salt or an inorganic salt of organic vascoconstrictors.

6. The retraction cord of claim 5, wherein the retracting agent comprises Aluminum Potassium Sulfate, Aluminum Sulfate, Aluminum Chloride, Ferric Sulfate, epinephrine, pseudoephedrine, or VISINE.

7. The retraction cord of claim 1, wherein the cord comprises a twisted cord, a braided cord, a knitted cord, or a cord including a ductile metal strand.

8. A retraction cord for retracting gingival tissue, comprising:
a cord pre-impregnated with a chemical agent selected from the group consisting of a retracting agent and a hemostatic agent;
a wetting agent comprising a surface active surfactant applied to the cord; and
wherein the cord comprises a twisted cord, a braided cord, a knitted cord, or a cord including a ductile metal strand.

9. The retraction cord of claim 8, wherein the wetting agent is a non-ionic surface active surfactant comprising a ZONYL fluorocarbon, a PLURONIC block copolymer of ethylene and propylene oxide to an ethylene glycol base, a TWEEN polyoxyethylene sorbitan fatty acid ester, a TRITON X series octylphenoxy polyethoxy ethanol, a SURFYNOL tetramethyl decynediol, a SILWET L-7614 silicon surfactant, or a SILWET L-7607 silicon surfactant.

10. The retraction cord of claim 9, wherein the surface active surfactant comprises SILWET L-7607 at a concentration of 0.05% by volume.

11. The retraction cord of claim 8, wherein the retracting agent comprises an astringent water soluble inorganic salt or an inorganic salt of organic vascoconstrictors.

12. The retraction cord of claim 11, wherein the retracting agent comprises Aluminum Potassium Sulfate, Aluminum Sulfate, Aluminum Chloride, Ferric Sulfate, epinephrine, pseudoephedrine, or VISINE.

13. A retraction cord for retracting gingival tissue, comprising:
a cord pre-impregnated with a chemical agent selected from the group consisting of a retracting agent and a hemostatic agent;
a wetting agent comprising SILWET L-7607 at a concentration of 0.05% by volume applied to the cord;
wherein the retracting agent comprises an astringent water soluble inorganic salt or an inorganic salt of organic vascoconstrictors; and
wherein the cord comprises a twisted cord, a braided cord, a knitted cord, or a cord including a ductile metal strand.

14. The retraction cord of claim 13, wherein the retracting agent comprises Aluminum Potassium Sulfate, Aluminum Sulfate, Aluminum Chloride, Ferric Sulfate, epinephrine, pseudoephedrine, or VISINE.

15. A retraction cord for retracting gingival tissue, comprising:
an elongate cord; and
a wetting agent comprising a surface active surfactant applied to the cord.

16. The retraction cord of claim 15, wherein the wetting agent is a non-ionic surface active surfactant comprising a ZONYL fluorocarbon, a PLURONIC block copolymer of ethylene and propylene oxide to an ethylene glycol base, a TWEEN polyoxyethylene sorbitan fatty acid ester, a TRITON X series octylphenoxy polyethoxy ethanol, a SURFYNOL tetramethyl decynediol, a SILWET L-7614 silicon surfactant, or a SILWET L-7607 silicon surfactant.

17. The retraction cord of claim 16, wherein the wetting agent comprises SILWET L-7607 at a concentration of 0.05% by volume.

18. The retraction cord of claim 15, wherein the cord comprises a twisted cord, a braided cord, a knitted cord, or a cord including a ductile metal strand.

19. The retraction cord of claim 15, wherein the cord is pre-impregnated with a chemical agent selected from the group consisting of a retracting agent and a hemostatic agent.

20. The retraction cord of claim 19, wherein the retracting agent comprises an astringent water soluble inorganic salt or an inorganic salt of organic vascoconstrictors.

21. The retraction cord of claim 20, wherein the retracting agent comprises Aluminum Potassium Sulfate, Aluminum Sulfate, Aluminum Chloride, Ferric Sulfate, epinephrine, pseudoephedrine, or VISINE.
